(19) United States
(12) Patent Application Publication
(10) Pub. No.: US 2010/0040755 A1
(43) Pub. Date: Feb. 18, 2010

(54) WHOLE EGG REPLACING NOVEL PREMIX CONCENTRATE SPECIALLY DESIGNED FOR CAKE AND CAKE RELATED PRODUCTS

(76) Inventors: Chandrakant Laxminarayan Rathi, Maharashtra (IN); Saylee Sameer Pradhan, Maharashtra (IN); Ahila Sriram, Tamilnadu (IN); Manoj Nair, Maharashtra (IN)

Correspondence Address: LADAS & PARRY LLP, 224 SOUTH MICHIGAN AVENUE, SUITE 1600, CHICAGO, IL, 60604, US

(21) Appl. No.: 12/527,582

(22) PCT Filed: Feb. 15, 2008
(86) PCT No.: PCT/IN08/00092

§ 371 Date: Aug. 18, 2009

(30) Foreign Application Priority Data
Feb. 20, 2007 (IN) 344/MUM/2007

(51) Int. Cl. A21D 10/04

(52) U.S. Cl. 426/552

(57) ABSTRACT

A Whole egg replacing novel premix concentrate specially designed for cake and cake related products wherein the said premix comprises isolates of protein from gramineae family—10-30% with isolates of milk based protein ranging from 20-40% and in conjunction with the emulsifier ranging from 5-15%, leavening system ranging from 1-10%, stabilizers such as calcium, sodium, potassium salts at about 7-10% with filler as starch and starch hydrolyzates.

### TECHNICAL FIELD

The present invention relates to a whole egg replacing dry concentrated powder premix specially used for vegetarian cake preparation comprising of scientifically blended isolates of protein from vegetative origin which in combination with blend of emulsifier selected from aeration or foam stability property and along with emulsification providing emulsifier or crumb softening emulsifier alone or in combination to give a complete organoleptic and rheological property similar to whole egg. The whole egg replacing dry concentrated powder premix is cholesterol free which in turn makes the human diet a complete.

### BACKGROUND AND PRIOR ART

A Cake is a form of food that normally combine some kind of flour, sweetening agent such as sugar, binding agents especially egg, fat, a liquid such as milk, water or juice and leavening agent such as baking powder or yeast.

Ready to use cake mixes simply require adding the package contents to eggs and oil in a bowl and mixing for two to three minutes. The mixture is then ready to be poured in pans and baked. But in the case of the present invention of whole egg replacing dry concentrated powder premix, the user has to mix the flour, sugar and liquid with the premix concentrate and then bake to get a cake.

Egg is a versatile food and food component. Although eggs are relatively low in calories and have high nutritional value, eggs are often restricted in the diet for reasons of the relatively high amount of saturated fats and cholesterol in the egg yolk. Natural egg whites also contain about 0.05% of avidin, a glycoprotein that combines with biotin or vitamin B6, making the biotin biologically unavailable. Biotin deficiency is known to cause adverse effects on the human immune system.

As organoleptic properties are influenced by the protein composition, the egg replacer composition requires to provide good rheological and organoleptic properties as the preparation of products such as cakes and cake related products depends heavily on the functional and organoleptic contribution from eggs.

Indian patent application No IN561/DEL/2004 describes a formulation for preparation of high proteins eggless cake and a process thereof, wherein the formulation comprises whey and whey derived products, for use in variety of food products. The said Whey derived products are useful besides being a nutritional ingredient in various foods can also be used as a functional ingredient for flavour binding, texturization, colour and aeration properties in a wide variety of food formulations. Whey proteins have very good functional attributes such as water binding, viscosity, foaming, emulsifying, gelling and solubility.

The whole egg replacing dry concentrated powder premix is cholesterol free, and devoid of avidin since it is free of whole egg and egg related products. The present invention attributes nutritional benefit as well as better organoleptic and rheological properties to the cakes and cake related products such as pastry etc. similar to that of whole egg.

WO/2004/073423 discloses egg replacer concentrate with low cholesterol content. It includes 40-85% protein, 10-50% vegetable oil and 0.5-15% carbohydrate. The cholesterol content is less than 0.5%. The protein includes soy protein, milk protein and optionally egg white protein, at least half of the protein being soy protein. The PDI is at least 60%. The concentrate is dispersed in water, and optionally egg whites, to provide a liquid egg replacer. The liquid egg replacer includes egg white protein and has a moisture content of 75-84%. It contains 16-28% of the egg replacer concentrate, 45-82% water and optionally egg white.

U.S. Pat. No. 4,103,038 disclose an egg replacer composition based on ultra filtration whey protein, fats and emulsifier.

U.S. Pat. No. 4,120,986 discloses the preparation of a high protein content material that contains 25-55% protein, 5-15% fat and 25-50% carbohydrate, which is further processed with emulsifier, lecithin, starch and gums to provide an egg replacer.

U.S. Pat. No. 4,360,537 disclose the preparation of a lipoprotein emulsion system based on soya isolate that can be used to replace egg yolk in various food products. In the preparation high amount of soluble carbohydrates and lecithin are included.

U.S. Pat. No. 5,725,899 discloses the preparation of a composition from soya flour and soy oil which on reconstitution in water forms a milk like protein beverage.

For the foregoing reasons, substantial efforts were made in the art to provide egg replacers sufficiently palatable yet free in saturated fats and cholesterol to be accepted by the vegetarians and dieters.

Many approaches have been proposed to replace the egg yolk or whole egg in the food products. But none of them had replaced the foaming, whipping and rheological properties similar to that of egg.

Therefore it was necessary to provide a dry powder premix concentrate which provides foaming, whipping and rheological properties which resembles to whole egg and also free from cholesterol and avidin.

### OBJECT OF THE INVENTION

The main object of present invention is to provide whole egg replacing dried powder concentrated premix comprising of scientifically blended isolates of protein from vegetative origin which in combination with the blend of emulsifiers for aeration/foam stability, emulsification or crumb softening, alone or in combination.

Another object of present invention is to provide the whole egg replacing dried powder concentrated premix comprising scientifically blended isolates of protein from vegetative origin which improves the solubility and functionality.

A still another objective of the invention is to provide emulsifier for aeration/foam stability, emulsification or crumb softening, alone or in combination which resembles the same property as that of whole egg attributing nutritional benefit as well as organoleptic properties to the cakes.

Yet another object of the invention is to provide whole egg replacement which is a dried powder mixture, which doesn't require any processing other than the blending of dry ingredients, easy to use, convenient in all process without modifying baker's recipes and process conditions.

### SUMMARY OF THE INVENTION

The present invention discloses a whole egg replacing dried powder concentrate premix comprising of scientifically blended isolates of protein from vegetative origin which in combination with the blend of emulsifiers for aeration/foam stability, emulsification or crumb softening, alone or in combination.

The invention further discloses a whole egg replacing dried powder premix concentrate comprising of blend of isolates of protein from vegetative origin, in combination with emulsifier blend, leavening system which gives combined synergistic effect with stabilizer such as calcium and sodium salts in combination with the filler selected from vegetative origin includes starch and starch hydrolyzates.

The whole egg replacing dried powder concentrate premix comprising of isolates of protein from gramineae family as well as milk based origin used in conjunction with the blend of emulsifiers for aeration/foam stability, emulsification or crumb softening, alone or in combination selected includes the various emulsifiers such as Distilled monoglyceride Polyglycerol ester of fatty acids, Propylene glycol fatty acid ester, Caseinate, stabilizers such as calcium, sodium salts, leavening system which consists of leavening agent in combination and filler is selected from vegetative origin specially designed starch and starch hydrolyzates.

### DESCRIPTION OF DRAWINGS

FIG. 1 describes Diagrammatic representation of Eggless cake.

FIG. 2 describes a graph for the interpretation of softness of cake by texture analyzer TA plus (Llyods) in example-1

FIG. 3 describes a graph for the interpretation of cutting strength of cake by texture analyser TA plus (Llyods) in example-1

FIG. 4 describes a graph for the interpretation of softness of cake by texture analyzer TA plus (Llyods) in example-2.

FIG. 5 describes a graph for the interpretation of cutting strength of cake by texture analyser TA plus (Llyods) in example-2

FIG. 6 describes a graph for the interpretation of softness of cake by texture analyzer TA plus (Llyods) in example-3

FIG. 7 describes a graph for the interpretation of cutting strength of cake by texture analyzer TA plus (Llyods) in example-3

FIG. 8 describes a graph for the interpretation of softness of cake by texture analyser TA plus (Llyods) in example-4

FIG. 9 describes a graph for the interpretation of cutting strength of cake by texture analyzer TA plus (Llyods) in example-4

FIG. 10 shows the graphical representation of comparison of organoleptic properties of cake prepared from whole egg replacing novel premix concentrate from example 4, batch 4 with different recipes.

FIG. 11 shows the graphical representation of textural and color properties like firmness values and cutting strength of the cake prepared from whole egg replacing premix concentrate from Example 4 batch 4 with different recipes.

FIG. 12 shows the graphical representation of Comparative study of organoleptic properties of cake prepared from Example 4 Batch 4 with competitor with recipe 2.12.

FIG. 13 shows the graphical representation of firmness values and cutting strength of the cake prepared from whole egg replacing premix concentrate from Example 4 batch 4 with competitor sample in recipe 2.

FIG. 14 shows the comparative study of Organoleptic properties of competitor I with Example 4 batch 4

FIG. 15 shows comparative study of Organoleptic properties of competitor II with Example 4 Batch 4.

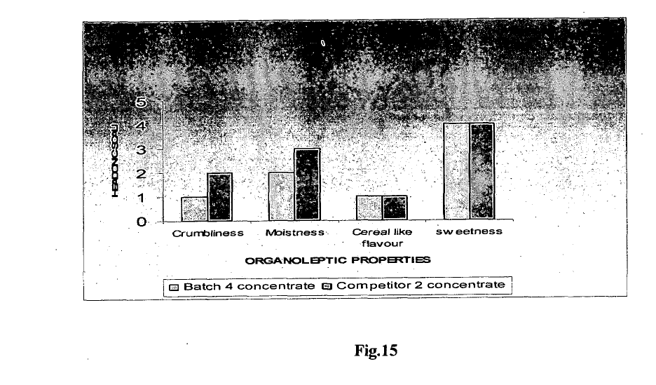

FIG. 16 shows comparative study of Organoleptic properties of competitor 3 with Example 4 Batch 4. please insert this figure as FIG. 16.

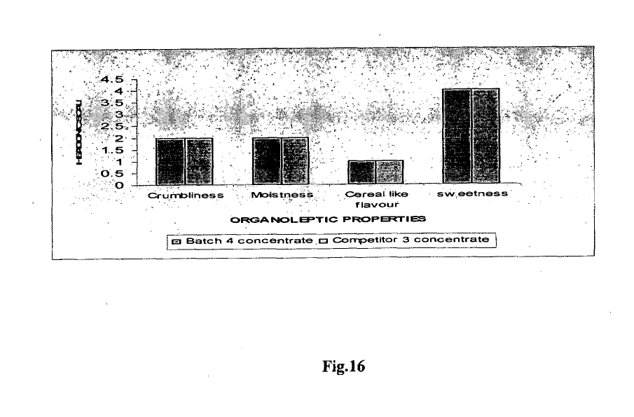

FIG. 17 shows comparative study of textural properties of Firm ness and cutting strengths of the cakes from Example 4 batch 4 and competitor I sample and their recipe.

FIG. 18 shows the comparative study of textural properties of firmness and cutting strength of cakes from Example 4 batch 4 and competitor II sample and their recipe.

FIG. 19 shows the comparative study of textural properties of firmness and cutting strength of cakes from Example 4 batch 4 and competitor III sample and their recipe.

FIG. 20 shows comparison of organoleptic properties of cake prepared from Example 4 Batch 4 formula and cake prepared using whole egg.

FIG. 21 shows graphical representation of Textural and colour properties firmness and cutting strength of the cake prepared from whole egg replacing premix concentrate from Example 4 batch 4 and cake from egg

FIG. 22 shows the graphical representation of moisture content

FIG. 23 shows the graphical representation of Protein content

FIG. 24 shows the graphical representation of Fat content

FIG. 25 shows the graphical representation of Ash content

FIG. 26 shows graphical representation of carbohydrate

FIG. 27 shows the graphical representation of nutritional profile of cake prepared from egg cake and cake prepared from whole egg replacing novel premix concentrate.

### DETAILED DESCRIPTION OF THE INVENTION

The invention will now be described in detail in connection with certain preferred and optional embodiments, so that various aspects thereof may be more fully understood and appreciated.

The present invention describes replacement of the whole egg with the dried powder concentrate premix comprising scientifically blended isolates of protein are from vegetative origin.

In one embodiment the invention describes the isolates of protein are selected from gramineae family includes cereals such as barley, wheat, oats, rye or maize as well as isolates of milk based origin in conjunction with the blend of emulsifiers for aeration/foam stability, emulsification or crumb softening, alone or in combination includes Distilled monoglyceride Polyglycerol ester of fatty acids, Propylene glycol fatty acid ester, stabilizers such as calcium, sodium, potassium salts and filler as starch and starch hydrolyzates.

In another embodiment the invention describes the range of composition of isolates of protein from gramineae family—10-30% with isolates of milk based protein ranging from 20-40% and in conjunction with the emulsifier ranging from 5-15%, leavening system comprising in the range of 1-10%, stabilizers such as calcium, sodium or potassium salts at 7-10% with fillers like starch or starch hydrolyzates as Q.S.

(1) Isolates of Milk protein: Milk protein is a very high quality complete protein with rich amounts of all the essential amino acids which are absorbed quickly and efficiently into the body. It also contains bioactive ingredients, like immunoglobulin and lactoferrin that supports the immune system. The isolates of milk based protein comprise at least one selected from the group of casein, whey protein isolates and concentrates, milk condensates. The mechanism of Isolates of Milk protein application in cakes is as follows:

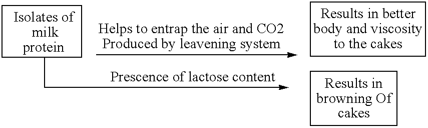

(2) Isolates of gramineae protein: The isolate of protein obtained from botanical Gramineae family includes cereals such as barley, wheat, oats, rye or maize which delivers extensibility, film forming properties and moisture management in cakes.
The mechanism of Isolates of gramineae family protein is as follows

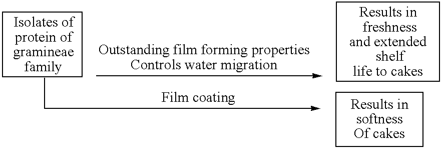

(3) Emulsifiers: Emulsifiers play a vital role in cake formulation. There are different types of emulsifiers such as sodium and calcium stearoyl lactylate, ethoxylated mono and di glycerides, polysorbates, succinylated mono glycerides, diacetyl tartaric acid esters of mono glycerides etc.

Emulsifier for aeration and foam stability: The emulsifiers such as Acetic acid ester of mono glycerides, lactic acid ester of mono glycerides, Propylene Glycerol Esters of Fatty Acids, coat the air cell in foams to provide foam stabilization. These emulsifiers decrease the surface tension of aqueous phase thereby increasing the whipping rate of cake batter.

Emulsifier for Emulsification: The emulsifiers such as mono and di glycerides, Polyglycerol Esters of Fatty Acids, Polyglycerol Polyricinoleate stabilizes emulsions and provides uniform and stable water dispersion.

Emulsifier for protein interaction: The emulsifiers such as calcium and sodium stearoyl lactylate interact with these proteins to build a stronger gluten network. The emulsifier also helps the protein molecules to associate with one another through hydrophobic interactions, hydrogen bonding or ionic interactions.

Emulsifier for crumb softening system: The emulsifier such as Diacetyl Tartaric Acid Esters possess excellent dough strengthening properties due to their ability to interact with the gluten in dough thereby enhance gas retention and improve dough tolerance to mechanical handling.

Stabilizers: The stabilizers such as the chlorides of sodium, calcium, potassium salts are usually used in cakes are known to enhance the sweetness and the flavors of other ingredients. They also play important role in strengthening proteins in flour and contributing to a golden, crisp crust in the final cake.

Leavening system: The leavening system used in cake mainly includes sodium bi carbonate, sodium acid pyro phosphate; sodium aluminum sulphate or potassium tartrate etc. cakes are leavened entirely by physical means such as air incorporation by Mixer during mixing and the oven spring in the oven which happens due to vapour pressure created during baking.

Filler: Basically fillers used in cakes are starch and starch hydrolyzates such as corn starch, maize starch or in combination with starch-maltodextrin or potato starch to provide a softer texture to the cake. They also increase the penetration values and shelf life of cakes by delaying the staling rate.

According to the present invention, whole egg replacing dried powder concentrated premix is prepared hygienically by maintaining the moisture content up to less than 4% so that the product has extended shelf life.

According to the present invention whole egg replacing dried powder concentrated premix prepared can be used in the range of 20-40% on flour weight basis.

The cakes prepared in the laboratory by the application of SINMAG BAKERY EQUIPMENTS OF TAIWAN.

### Schematic Representation of Flow Chart for Cake Preparation:

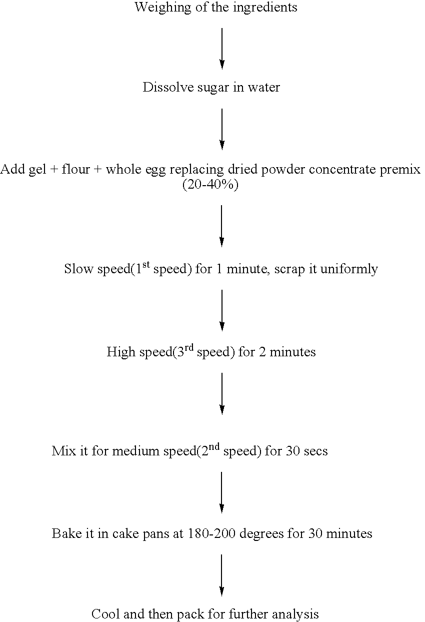

Therefore, according to the present invention, a method for preparing cake and cake related products from Whole egg replacing novel premix concentrate is as follows
a) whisking the sugar and water until the sugar dissolves;
b) adding cake gel, flour mixed with the eggless concentrate with 60 revolutions speed followed by a high speed of 180 revolutions until the uniform mixture obtained;
c) adding oil by mixing it in slow speed of 60 revolutions for 30 seconds; and
d) baking the mixture in cake pan of smaller size (6″-2″) and larger pan size of (6½-2½ inch) of batter weight 250 gms and 600 gms respectively.

The following examples, which include preferred embodiments, will serve to illustrate the practice of this invention, it being understood that the particulars shown are by way of example and for purpose of illustrative discussion of preferred embodiments of the invention.

### EXAMPLES

The composition of whole egg replacing dried powder concentrate premix is followed as described in the following examples

### Example 1, Batch 1

| Ingredients | Quantity in grams |
|---|---|
| Isolate of Protein from milk base | 10-30% |
| Isolate of Protein from gramineae family | 20-40% |
| Emulsifier system | 5-15% |
| Leavening system | 1-10% |
| Stabilizer | 7-10% |
| Filler | Q.S |

Recipe: (For 1 kg batter weight of cake) Cake flour—285 gms, sugar—255 gms, water—307 ml, gel—23 gm, oil—40 gm, eggless premix concentrate—100 gm. Note: Cake Gel usage 8% and Eggless premix concentrate 35% on the weight of flour basis.

The cake gel which is used as one of the ingredient in the cake preparations nothing but the combined Emulsifier System. The emulsifier used in the system are selected from the Emulsifier for aeration and foam stability, emulsification or for protein interaction. the emulsifier system such as mono and di glycerides, sodium and calcium stearoyl lactylate, ethoxylated mono and di glycerides, polysorbates, succinylated mono glycerides in combination wherein the oil phase and water phase are mixed and heated to 80 degrees and poured, allowed to settle.

Equipment used: Planetary Mixer Model Q70 (From Sinmag bakery equipments of Taiwan)

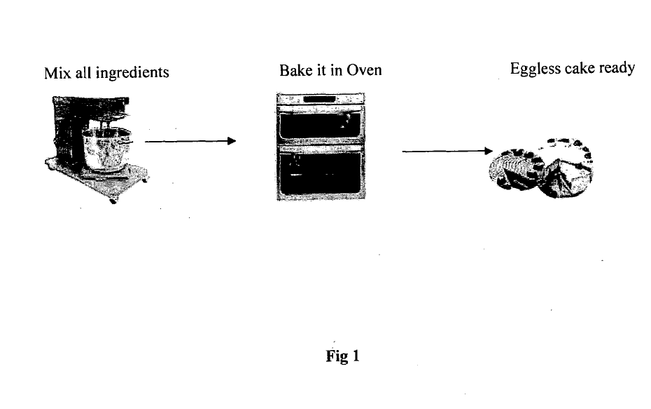

Procedure: Sugar and water is whisked first. Once the sugar is dissolved, then add gel, flour mixed with the eggless concentrate with 60 revolutions speed. Once it is uniformly mixed, scrap it from side and then mix it in a high speed of revolutions of 180. Add oil and mix it in slow speed of 60 revolutions for 30 seconds. Bake it in cake pan of smaller size (6″-2″) and larger pan size of (6½-2½ inch) of batter weight 250 gms and 600 gms respectively. The diagrammatic representation of eggless cake is shown in FIG. 1.

Hunter Lab Colorimeteric Reading

| L value | a value | b value |
|---|---|---|
| 83.91 | 0.25 | 17.10 |

L equals 0-100 (0 = black and 100 = white)
a equals red to green (+ = red and − = green)
b equals yellow to blue (+ = yellow and − = blue)

Softness of Cake by Texture Analyser TA Plus (Llyods)

| | | | Deflection At |
|---|---|---|---|
| Test Speed | Test Parameter | Firmness | Maximum Load |
| 10 mm/Min | Preload No | 2.2468 | 20.011 |
| | Stop At 20 mm | | |

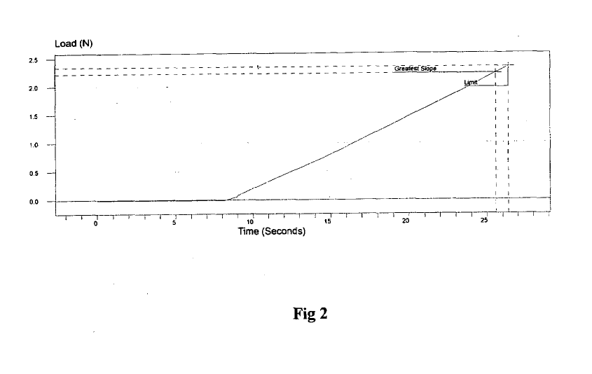

More the firmness value, more hard the cake is. Lower the firmness value, more soft the Cake is. A graph for representation of the softness of cake by texture analyzer TS plus (Lloyds) is shown in FIG. 2.

Cutting Strength of Cake by Texture Analyser TA Plus (Llyods)

| Test Speed | Test Parameter | Break Strength | Deformation |
|---|---|---|---|
| 50 mm/Min | TRIGGER:- | 55.14 N | 5.86 |
| | 0.5 N | | |
| | LIMIT:- 15 mm | | |

Lower the value of break strength, cutting is proper and uniform

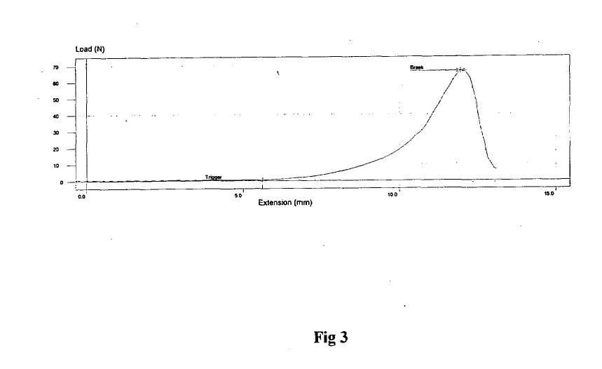

Deformation value also show how much the texture got distorted due to that particular load. A graph showing the interpretation of cutting strength of cake by texture analyzer TA plus is shown in FIG. 3.

### Observations of Cake Batter:

Cake batter density is measured by cake batter density (gm/cc)=weight of batter volume.

### Texture Analyser

Textural property is main and most important quality characteristics of cake. Textural property of the cake can be given by two parameters
1. cutting strength
2. Firmness (softness)

### Cutting Strength:

This test is done by Texture Analyser TA Plus (LYYODS) with software attached with it. The cake was cut into uniform slice of required thickness. The slice was kept on the mount table. A load cell of 1 KN is used. The snap strength test is used for cutting strength. Snap strength is the measure the relaxation of a food while it is compressed for a specified time. The crosshead speed for this test is 50 mm/min. Trigger load is 0.5 N and limit is 15 mm. Several parameters were obtained including maximum load, Deformation rate, Break and Break Strength. All the tests are carried out in 5 repetitions and the average values were calculated and used for statistical analysis. Cutting strength is a type of break test.

### Break Test:

Break test will either stop at limit as described above or when a break is detected. There are 2 types of break detector: a % break detector which detects when the load has dropped to 50% of the maximum peak load detected and a sharp break detector. The sharp break detector operates when there has been a sharp change in load or direction between one load reading and the next.

### Firmness:

This test is also done by Texture Analyser TA plus (LYYODS) with software attached with it. Cake of same weight has been taken. A load cell of 1 KN is used. General purpose compress to limit test is used. This test which is carried out to a limit. The limits are defined in mm or elongation (after setting gauge length) or inches, newtons kg force, lbs force, mega pascal's (have entered the sample dimensions), kg force per mm2 and lb force pa inch2. test speed is 10 mm/min. The parameters which we get for softness are load at limit, deflection at limit, work to limit, firmness, deflection at maximum load, work to maximum load etc. All the testes are repeated for 5 times and the average values are calculated and used for statistical analysis.

Laboratory internal standards for

### SOFTNESS/FIRMNESS OF CAKE: (by Texture Analyser):

For eggless cake: 2 to 4
CUTTING STRENGTH OF CAKE: (by texture analyzer)
Breaking strength: 50 to 60

### Deformation: 5 to 6

### Example 2

### Batch 2

| Ingredients | Quantity in grams |
|---|---|
| Isolate of Protein from milk base | 10-30% |
| Isolate of Protein from gramineae family | 20-40% |
| Emulsifier system 1 | 3-7% |
| Emulsifier system 2 | 2-8% |
| Leavening system | 1-10% |
| Stabilizer | 7-10% |
| Filler | Q.S |

Recipe: (For 1 kg batter weight of cake) Cake flour—285 gms, sugar—255 gms, water—307 ml, gel—23 gm, oil—40 gm, eggless premix concentrate—100 gm. Note: Gel usage 8% and Eggless premix concentrate 35% on the weight of flour basis.

Equipment used: Planetary Mixer Model Q70 (From Sinmag bakery equipments of Taiwan)

Procedure: Sugar and water is whisked first. Once the sugar is dissolved, then add gel, flour mixed with the eggless concentrate with 60 revolutions speed. Once it is uniformly mixed, scrap it from side and then mix it in a high speed of revolutions of 180. Add oil and mix it in slow speed of 60 revolutions for 30 seconds. Bake it in cake pan of smaller size (6″-2″) and larger pan size of (6½-2½ inch) of batter weight 250 gms and 600 gms respectively.

### Observations: HUNTERLAB COLORIMETERIC READING

| L value | a value | b value |
|---|---|---|
| 84.61 | 0.31 | 16.98 |

L equals 0-100 (0 = black and 100 = white)
a equals red to green (+ = red and − = green)
b equals yellow to blue (+ = yellow and − = blue)

Texture Analyser TA Plus (Llyods)

| | | | Deflection At |
|---|---|---|---|
| Test Speed | Test Parameter | Firmness | Maximum Load |
| 10 mm/Min | Preload No | 2.2145 | 20.011 |
| | Stop At 20 mm | | |

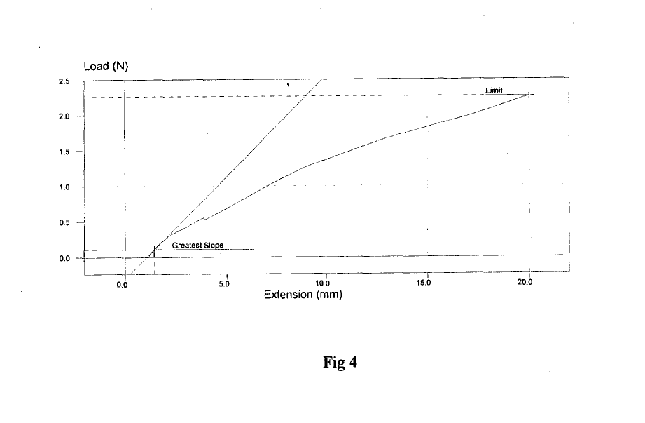

More the firmness value, more hard the cake is. Lower the firmness value, more soft the cake is. A graph for representation of the softness of cake by texture analyzer TS plus (Lloyds) is shown in FIG. 4.

Cutting Strength of Cake by Texture Analyser TA Plus (Llyods)

| | | | Deflection At |
|---|---|---|---|
| Test Speed | Test Parameter | Firmness | Maximum Load |
| 10 mm/Min | Preload No | 2.2145 | 20.011 |
| | Stop At 20 mm | | |

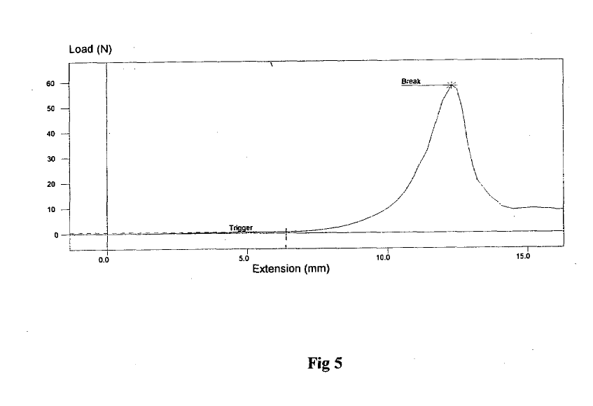

Lower the value of break strength, cutting is proper and uniform Deformation also show how much the texture got distorted due to that particular load. A graph showing the interpretation of cutting strength of cake by texture analyzer TA plus is shown in FIG. 5.

### Example 3

### Batch 3

| Ingredients | Quantity in grams |
|---|---|
| Isolate of Protein from milk base | 10-30% |
| Isolate of Protein from gramineae family | 20-40% |
| Emulsifier system 1 | 3-7% |
| Emulsifier system 2 | 2-8% |
| Leavening system 1 | 1-5% |
| Leavening system 2 | 1-10% |
| Stabilizer | 7-10% |
| Filler | Q.S |

Recipe: (For 1 kg batter weight of cake) Cake flour—285 gms, sugar—255 gms, water—307 ml, gel—23 gm, oil—40 gm, eggless premix concentrate—100 gm. Note: Gel usage 8% and Eggless premix concentrate 35% on the weight of flour basis.

Equipment used: Planetary Mixer Model Q70 (From Sinmag bakery equipments of Taiwan)

Procedure: Sugar and water is whisked first. Once the sugar is dissolved, then add gel, flour mixed with the eggless concentrate with 60 revolutions speed. Once it is uniformly mixed, scrap it from side and then mix it in a high speed of revolutions of 180. Add oil and mix it in slow speed of 60 revolutions for 30 seconds. Bake it in cake pan of smaller size (6″-2″) and larger pan size of (6½-2½ inch) of batter weight 250 gms and 600 gms respectively.

### Observations:

Hunterlab Colorimeteric Reading

| L value | a value | b value |
|---|---|---|
| 83.90 | 0.31 | 16.98 |

L equals 0-100 (0 = black and 100 = white)
a equals red to green (+ = red and − = green)
b equals yellow to blue (+ = yellow and − = blue)

Texture Analyser TA Plus (Llyods)

| | | | Deflection At |
|---|---|---|---|
| Test Speed | Test Parameter | Firmness | Maximum Load |
| 10 mm/Min | Preload No | 2.1345 | 20.011 |
| | Stop At 20 mm | | |

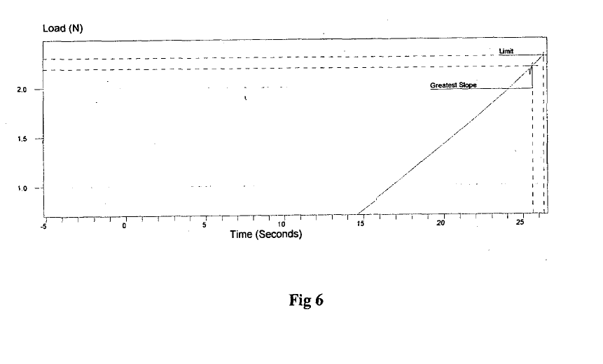

More the firmness value, more hard the cake is. Lower the firmness value, more soft the cake is. A graph for representation of the softness of cake by texture analyzer TS plus (Lloyds) is shown in FIG. 6.

Cutting Strength of Cake by Texture Analyser TA Plus (Llyods)

| Test Speed | Test Parameter | Break Strength | Deformation |
|---|---|---|---|
| 50 mm/Min | TRIGGER:- | 53.01 N | 5.72 |
| | 0.5 N | | |
| | LIMIT:- 15 mm | | |

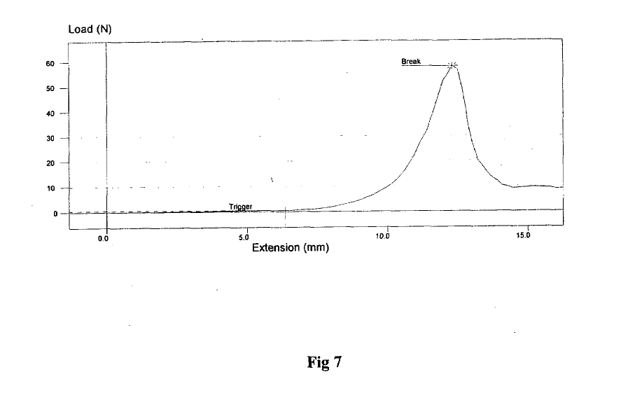

Lower the value of break strength, cutting is proper and uniform Deformation also show how much the texture got distorted due to that particular load. A graph showing the interpretation of cutting strength of cake by texture analyzer TA plus is shown in FIG. 7.

### Example 4

### Batch 4

### Ingredients Quantity in Grams

| Ingredients | Quantity in grams |
|---|---|
| Isolate of Protein from milk base | 10-30% |
| Isolate of Protein from gramineae family | 20-40% |
| Emulsifier system 1 | 3-7% |
| Emulsifier system 2 | 2-8% |
| Leavening system 1 | 1-5% |
| Leavening system 2 | 1-10% |
| Stabilizer | 7-10% |
| Filler 1 | Q.S |
| Filler 2 | Q.S |

Recipe: (For 1 kg batter weight of cake) Cake flour—285 gms, sugar—255 gms, water—307 ml, gel—23 gm, oil-—40 gm, eggless premix concentrate—100 gm. Note: Gel usage 8% and Eggless premix concentrate 35% on the weight of flour basis.

Equipment used: Planetary Mixer Model Q70 (From Sinmag bakery equipments of Taiwan)

Procedure: Sugar and water is whisked first. Once the sugar is dissolved, then add gel, flour mixed with the eggless concentrate with 60 revolutions speed. Once it is uniformly mixed, scrap it from side and then mix it in a high speed of revolutions of 180. Add oil and mix it in slow speed of 60 revolutions for 30 seconds. Bake it in cake pan of smaller size (6″-2″) and larger pan size of (6½-2½ inch) of batter weight 250 gms and 600 gms respectively.

### Observations:

Hunterlab Colorimeteric Reading

| L value | a value | b value |
|---|---|---|
| 84.62 | 0.31 | 16.98 |

L equals 0-100 (0 = black and 100 = white)
a equals red to green (+ = red and − = green)
b equals yellow to blue (+ = yellow and − = blue)

Texture Analyser TA Plus (Llyods)

| | | | Deflection At |
|---|---|---|---|
| Test Speed | Test Parameter | Firmness | Maximum Load |
| 10 mm/Min | Preload No | 2.1145 | 20.011 |
| | Stop At 20 mm | | |

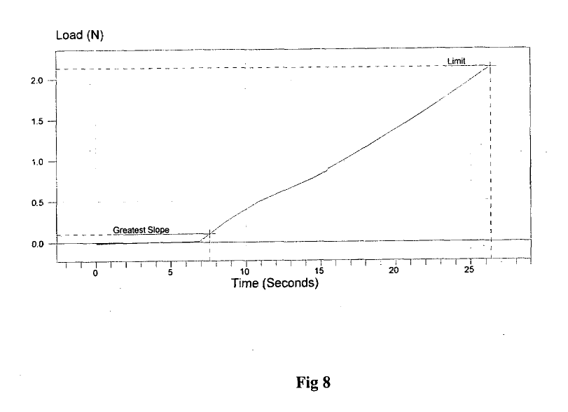

More the firmness value, more hard the cake is. Lower the firmness value, more soft the cake is. A graph for representation of the softness of cake by texture analyzer TS plus (Lloyds) is shown in FIG. 8.

Cutting Strength of Cake by Texture Analyser TA Plus (Llyods)

| Test Speed | Test Parameter | Break Strength | Deformation |
|---|---|---|---|
| 50 mm/Min | TRIGGER: - 0.5 N | 51.01 N | 5.68 |
| | LIMIT: - 15 mm | | |

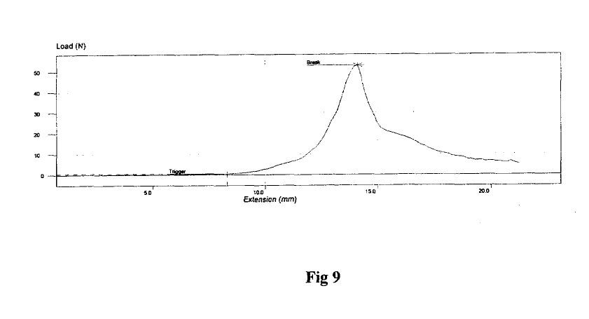

Lower the value of break strength, cutting is proper and uniform Deformation also show how much the texture got distorted due to that particular load. A graph showing the interpretation of cutting strength of cake by texture analyzer TA plus is shown in FIG. 9.

### Sensory Evaluation:

The above cakes which were prepared are analyzed for its sensory properties such as crumbliness, grittiness, cell size and cereal like flavour. The panel of 12 members was trained. The pulled results are as follows:

### Sensory Evaluation of Cakes

| | | | Cereal like | |
|---|---|---|---|---|
| Cakes | Crumbliness | moistness | flavour | sweetness |
| Batch 1 | 4 | 8 | 3 | 6.5 |
| Batch 2 | 2 | 8.14 | 3 | 6.8 |
| Batch 3 | 2 | 8.2 | 3 | 6.8 |
| Batch 4 | 2 | 8.15 | 3 | 6.9 |

Scores are based on 0-15 headonic scale

0=fine cell size, low degree of crumbliness, dry, no grittiness, low degree of sweetness, or no cereal-like flavor.
15=coarse, cell size, high degree of crumbliness, high degree of moistness, high degree Of grittiness, high degree of sweetness, or high degree of cereal-like flavor.

From the above examples cake prepared from whole egg replacing novel premix concentrate from Example 4 batch 4 has shown better organoleptic properties, textural properties and sensory evaluation scores. Hence cake prepared from whole egg replacing novel premix concentrate from Example 4 batch 4 is standardized and comparative study has been done according to the internal processing conditions with the various recipes received from different bakeries all over India.

### Comparison Between the Cake Recipes:

The whole egg replacing novel premix concentrate from Example 4, Batch 4 has been compared with the different recipes received from Bakeries all over India. Three different types of recipes have been compared.

| Ingredients | Recipe 1 | | Recipe 2 | | Recipe 3 | |
|---|---|---|---|---|---|---|
| Flour | 285 | gms | 285 | gms | 285 | gms |
| sugar | 255 | gms | 296 | gms | 285 | gm |
| water | 307 | ml | 342 | ml | 357 | gm |
| concentrate | 100 | gm | 114 | gm | 100 | gm |
| Cake gel | 23 | gm | 23 | gm | 23 | gm |
| oil | 40 | gm | 40 | gm | 40 | gm |

Procedure: Sugar and water is whisked first. Once the sugar is dissolved, then add cake gel, and flour. Mixed with the whole egg replacing novel premix concentrate with 60 revolutions per minute speed. Once it is uniformly mixed, scrap it from side and then mix it in a high speed of revolutions of 180. Add oil and mix it in slow speed of 60 revolutions for 30 seconds. Bake it in cake pan of smaller size (6″-2″) and larger pan size of (6½-2½ inch) of batter weight 250 gms and 600 gms respectively. After cooling the cakes are evaluated for organoleptic analysis, texture and colour analysis.

### Organoleptic Analysis

| | | | Cereal like | |
|---|---|---|---|---|
| Cakes | Crumbliness | Moistness | flavour | sweetness |
| Recipe 1 | 2 | 3 | 1 | 4 |
| Recipe 2 | 1 | 3 | 1 | 4 |
| Recipe 3 | 2 | 3 | 1 | 4 |

Scores based on headonic scale.

0—less crumbly, less moist, low degree of sweetness, no cereal like flavour
5—More crumbly, more moistness, high degree of sweetness, high degree of cereal like flavour

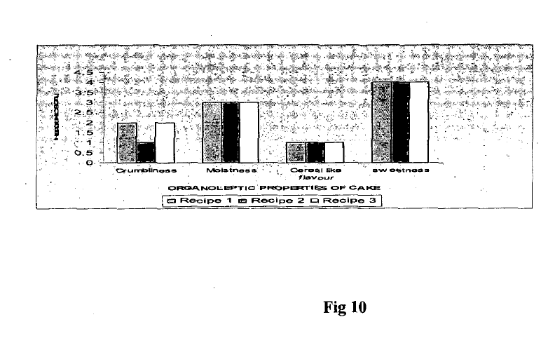

The graphical representation of the above comparisons of organoleptic properties of cake prepared from whole egg replacing novel premix concentrate from Example 4 Batch 4 in different recipes is shown in FIG. 10

### Texture and Colour Analysis

| | Hunterlab colorimeter | | | | |
|---|---|---|---|---|---|
| | reading | | | | Cutting |
| Cakes | L | a | b | firmness | strength |
| Recipe 1 | 83.26 | 0.21 | 11.25 | 2.11 | 51.05 |
| Recipe 2 | 84.76 | 0.22 | 10.98 | 1.99 | 50.12 |
| Recipe 3 | 83.78 | 0.18 | 11.12 | 2.07 | 50.02 |

### Where

1. L equals 0-100 (0=black and 100=white)
a equals red to green (+=red and−=green)
b equals yellow to blue (+=yellow and−=blue)
   2. More the firmness value, more hard the cake is. Lower the firmness value, more soft the cake is. Internal firmness value ranges between (2-4)
   3. Lower the value of break strength, cutting is proper and uniform Deformation also show how much the texture got distorted due to that particular load. Internal cutting strength value ranges between (50.0 to 60.0)

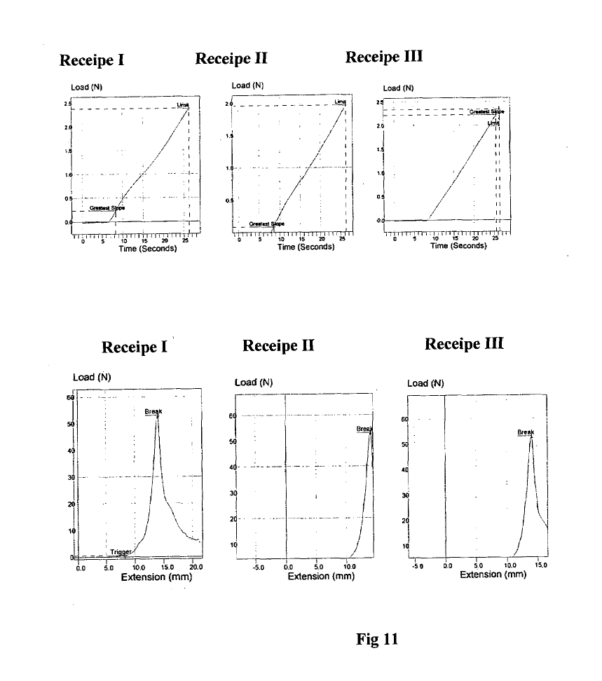

Graphical representation of Textural and colour properties of firmness values and cutting strength of the cake prepared from whole egg replacing premix concentrate from Example 4 batch 4 with different recipes as shown in FIG. 11.

From the above recipe I, recipe II and recipe III, the cake prepared from whole egg replacing novel premix concentrate with Recipe 2 has better organoleptic properties, textural properties. Hence the recipe 2 has been standardized for further competitor studies

### Comparative Study of Competitor Samples and Example 4 Batch 4 Whole Egg Replacing Premix Concentrate

The competitor samples are procured from the market all over India and the following study has been conducted. Comparative study of the cake prepared from whole egg replacing novel premix concentrate from Example 4 Batch 4 with competitor samples using Recipe 2.

Samples: Example 4 Batch 4, Competitor 1, Competitor 2, and Competitor 3

Recipe 2: (For 1 kg batter weight of cake) Cake flour—285 gms, sugar—295 gms, water—342 ml, cake gel—23 gm, oil—40 gm, Eggless premix concentrate—114 gm.

Equipment used: Planetary Mixer Model Q70 (From Sinmag bakery equipments of Taiwan)

Procedure: Sugar and water is whisked first. Once the sugar is dissolved, then add cake gel, and flour. Mixed with the eggless concentrate with 60 revolutions speed. Once it is uniformly mixed, scrap it from side and then mix it in a high speed of revolutions of 180. Add oil and mix it in slow speed of 60 revolutions for 30 seconds. Bake it in cake pan of smaller size (6″-2″) and larger pan size of (6½-2½ inch) of batter weight 250 gms and 600 gms respectively.

### Organoleptic Analysis

| | | | Cereal like | |
|---|---|---|---|---|
| Cakes | Crumbliness | Moistness | flavour | sweetness |
| Example 4 | 1 | 2 | 1 | 4 |
| Batch 4 | | | | |
| Competitor 1 | 3 | 4 | 2 | 2 |
| Competitor 2 | 3 | 4 | 3 | 3 |
| Competitor 3 | 4 | 4 | 3 | 4 |

Scores based on headonic scale.
1—less crumbly, less moist, low degree of sweetness, no cereal like flavour
5—More crumbly, more moistness, high degree of sweetness, high degree of cereal like flavour

From the above scores, the cake prepared using whole egg replacing novel premix concentrate from Example 4 Batch 4 has less crumbliness, controlled moisture, acceptable cereal like flavour and acceptable sweetness.

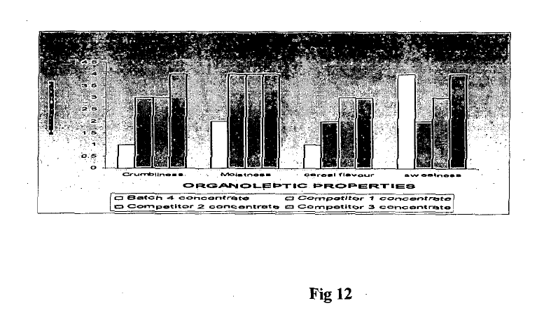

The graphical representation of comparison of organoleptic properties of cake prepared from whole egg replacing novel premix concentrate from Example 4 Batch 4 with competitor sample using Recipe 2 as shown in FIG. 12.

### Texture and Colour Analysis

| | Hunterlab | | | | |
|---|---|---|---|---|---|
| | colorimeter reading | | | | Cutting |
| Cakes | L | a | b | firmness | strength |
| Example 4 | 83.26 | 0.21 | 11.25 | 1.99 | 50.02 |
| Batch 4 | | | | | |
| Competitor 1 | 80.12 | 0.12 | 14.26 | 2.53 | 51.12 |
| Competitor 2 | 82.52 | 0.19 | 11.13 | 2.33 | 52.23 |
| Competitor 3 | 80.12 | 0.18 | 13.26 | 2.12 | 52.12 |

### Where

1. L equals 0-100 (0=black and 100=white)
a equals red to green (+=red and−=green)
b equals yellow to blue (+=yellow and−=blue)
   2. More the firmness value, more hard the cake is. Lower the firmness value, more soft the cake is. The firmness value ranges between (2 to 4)
   3. Lower the value of break strength, cutting is proper and uniform Deformation also show how much the texture got distorted due to that particular load. The cutting strength value ranges between (50.0 to 60)

From the above textural and colour properties, cake prepared from whole egg replacing novel premix concentrate from Example 4 batch 4 has better softness and uniform cutting strength value when compared with competitor samples I, II and III using Recipe 2.

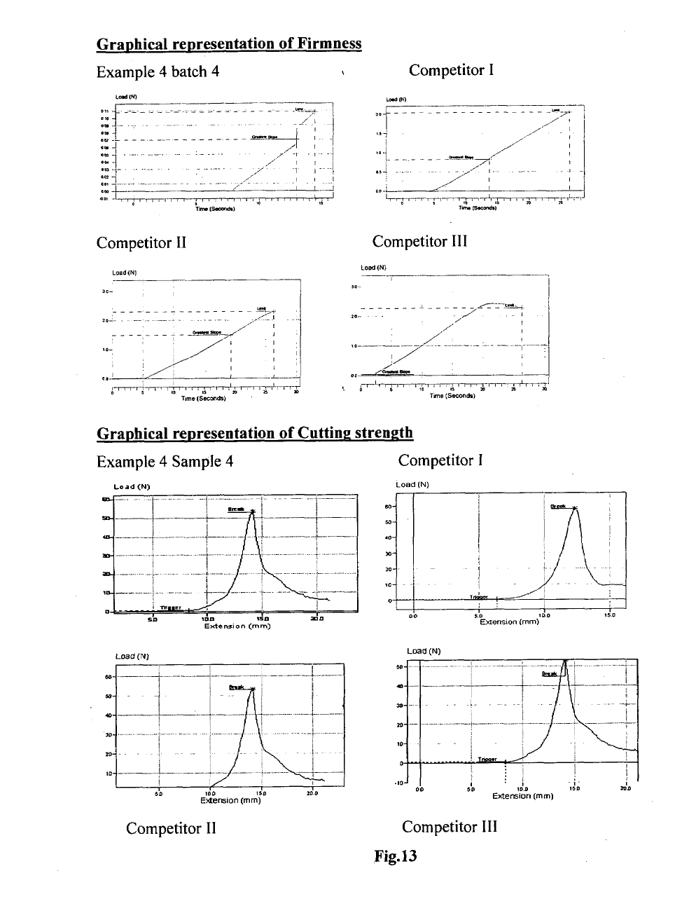

Graphical representation of Textural and colour properties of cake prepared from whole egg replacing premix concentrate from Example 4 batch 4 with competitor sample in Recipe 2 is shown in FIG. 13

### Comparative Study of Competitor Sample and their Recipe with Example 4 Batch 4 Premix Concentrate

Samples used: competitor I, Competitor II, Competitor III and Example 4 batch 4 sample

### Competitor Recipes

| | | | | | Competitor III | |
|---|---|---|---|---|---|---|
| Ingredients | Competitor I recipe | | Competitor II recipe | | recipe | |
| Flour | 250 | gms | 300 | gms | 300 | gms |
| sugar | 200 | gms | 220 | gms | 220 | gms |
| water | 300 | ml | 300 | ml | 300 | ml |
| concentrate | 100 | gm | 100 | gm | 100 | gm |
| Cake gel | 30 | gm | 10 | gm | 10 | gm |
| oil | 80 | gm | 50 | gm | 50 | gm |

Procedure: Sugar and water is whisked first. Once the sugar is dissolved, then add cake gel, and flour. Mixed with the eggless concentrate with 60 revolutions speed. Once it is uniformly mixed, scrap it from side and then mix it in a high speed of revolutions of 180. Add oil and mix it in slow speed of 60 revolutions for 30 seconds. Bake it in cake pan of smaller size (6″-2″) and larger pan size of (6½-2½ inch) of batter weight 250 gms and 600 gms respectively. After cooling the cakes are evaluated for organoleptic analysis, texture and colour analysis.

### Organoleptic Analysis

| | | | Cereal like | |
|---|---|---|---|---|
| Cakes | Crumbliness | Moistness | flavour | sweetness |
| Batch 4 | 1 | 2 | 1 | 4 |
| concentrate | | | | |
| Competitor I | 1 | 2 | 1 | 4 |
| Competitor II | 2 | 3 | 1 | 4 |
| Competitor III | 2 | 2 | 1 | 4 |

Scores based on headonic scale.
0—less crumbly, less moist, low degree of sweetness, no cereal like flavour
5—More crumbly, more moistness, high degree of sweetness, high degree of cereal like flavour

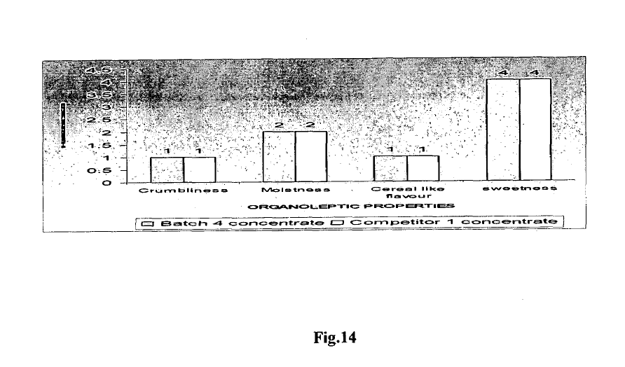

The graphical representation of comparison of organoleptic properties of cake prepared from whole egg replacing novel premix concentrate from Example 4 Batch 4 with competitor samples I, II, III and their recipes respectively as described in FIGS. 14,15,16.

### Texture and Colour Analysis:

| | Hunterlab colorimeter | | | | |
|---|---|---|---|---|---|
| | reading | | | Cutting | |
| Cakes | L | a | b | firmness | strength |
| Batch 4 | 82.26 | 0.21 | 11.32 | 1.99 | 50.02 |
| concentrate | | | | | |
| Competitor I | 82.12 | 0.12 | 11.22 | 1.95 | 50.12 |
| Competitor II | 82.56 | 0.14 | 11.43 | 2.11 | 51.21 |
| Competitor III | 81.72 | 0.13 | 12.36 | 2.25 | 50.48 |

### Where

1. L equals 0-100 (0=black and 100=white)
a equals red to green (+=red and−=green)
b equals yellow to blue (+=yellow and−=blue)
   2. More the firmness value, more hard the cake is. Lower the firmness value, more soft the cake is (2 to 4)
   3. Lower the value of break strength, cutting is proper and uniform Deformation also show how much the texture got distorted due to that particular load (50.0 to 60)

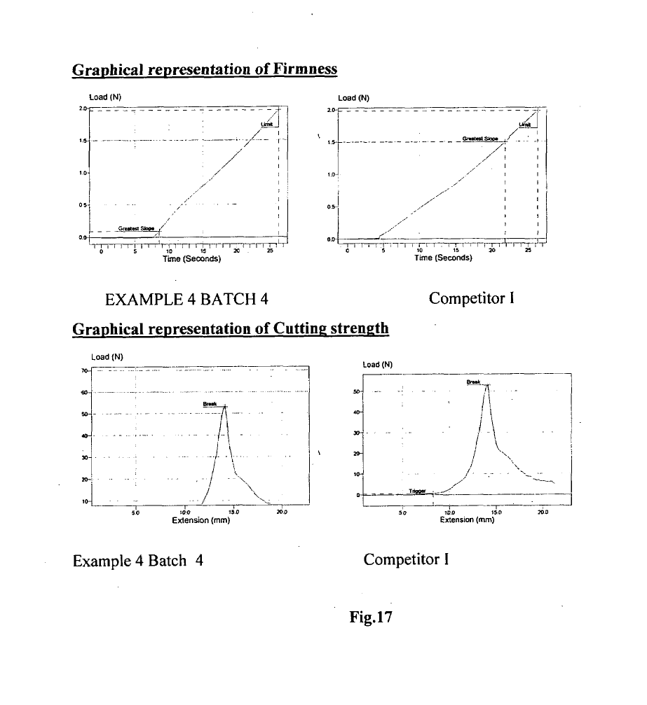

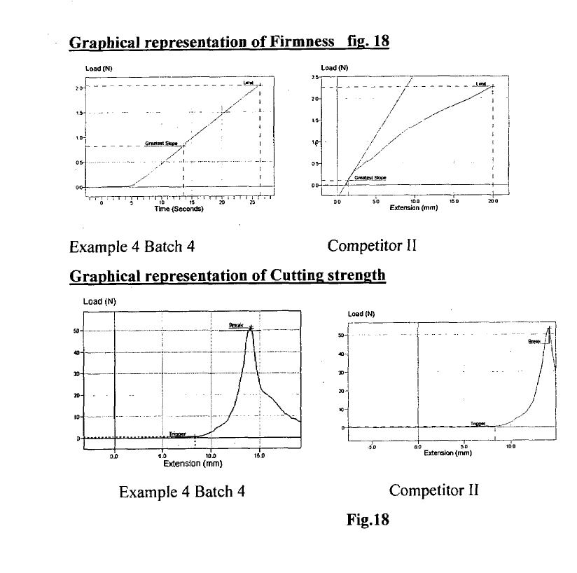

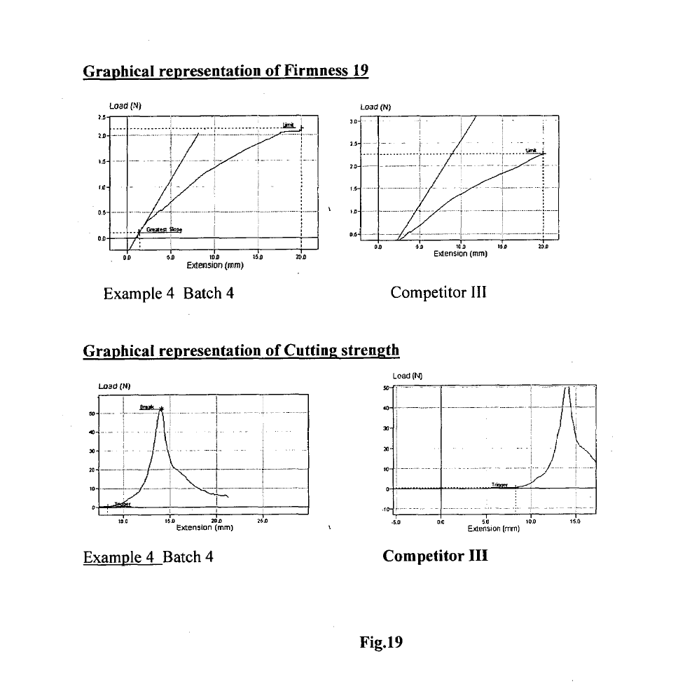

Graphical representation of textural properties of cake prepared from Example 4 Batch 4 premix in comparison with competitor I, II AND III and their recipes were described in FIGS. 17, 18 and 19 respectively.

### Comparative Study of Cake Prepared with Whole Egg and Cake Prepared from Whole Egg Replacing Novel Premix Concentrate Using Example 4 Batch 4 Formula

The cake prepared from whole egg replacing novel premix concentrate from Example 4 Batch 4 is compared with egg cake for its organoleptic and textural properties. The results are as follows:

### Samples Used:

Whole egg for egg cake, Example 4 Batch 4 concentrate (Whole egg replacing novel premix concentrate).

### Recipe for Egg Cake

| Ingredients | Quantity in gm | |
|---|---|---|
| Flour | 250 | gm |
| sugar | 250 | gm |
| Cake gel | 12.5 | gm |
| Whole egg | 300 | gm |
| Baking powder | 3.75 | gm |
| salt | 2.5 | gm |
| water | 62.5 | ml |

Procedure: Mix Sugar, water, eggs and gel on slow speed of 60 revolutions speed till the sugar dissolves. Once it is uniformly mixed, scrap it from side and add Maida, salt, baking powder and mix in a high speed of revolutions of 180. Bake it in cake pan of smaller size (6″-2″) and larger pan size of (6½-2½ inch) of batter weight 250 gms and 600 gms respectively. After cooling the cakes are evaluated for organoleptic analysis, texture and colour analysis.

### Organoleptic Analysis

| | | | Cereal like | |
|---|---|---|---|---|
| Cakes | Crumbliness | Moistness | flavour | sweetness |
| Cake prepared from | 1 | 3 | 1 | 4 |
| egg | | | | |
| Cake prepared from | 1 | 3 | 1 | 4 |
| whole egg replacing | | | | |
| novel premix | | | | |
| concentrate using | | | | |
| Example 4 batch 4 | | | | |
| formula | | | | |

Scores based on hedonic scale.
2—less crumbly, less moist, low degree of sweetness, no cereal like flavour
5—More crumbly, more moistness, high degree of sweetness, high degree of cereal like flavour

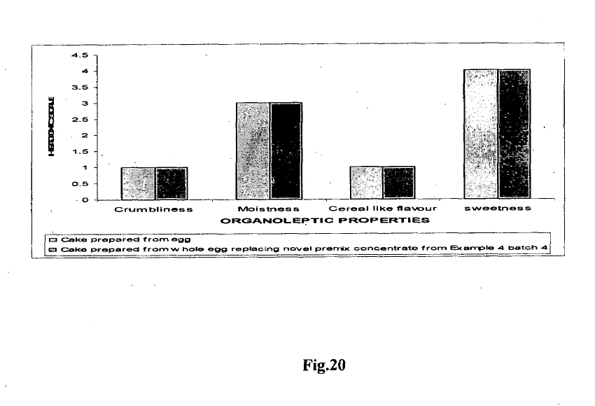

The graphical representation of comparison of organoleptic properties of cake prepared from whole egg replacing novel premix concentrate from Example 4 Batch 4 and cake prepared from egg as shown in FIG. 20.

### Texture and Colour Analysis:

| | Hunter lab colorimeter | | | | |
|---|---|---|---|---|---|
| | reading | | | | Cutting |
| Cakes | L | a | b | firmness | strength |
| Cake prepared using | 82.26 | 0.11 | 10.21 | 1.98 | 50.21 |
| whole egg | | | | | |
| Cake prepared from | 82.35 | 0.13 | 10.12 | 1.99 | 50.12 |
| whole egg replacing | | | | | |
| novel premix | | | | | |
| concentrate using | | | | | |
| Example 4 batch 4 | | | | | |

### Where

1. L equals 0-100 (0=black and 100=white)
a equals red to green (+=red and−=green)
b equals yellow to blue (+=yellow and−=blue)
   2. More the firmness value, more hard the cake is. Lower the firmness value, more soft the cake is. The firmness value ranges between 2 to 4
   3. Lower the value of break strength, cutting is proper and uniform Deformation also show how much the texture got distorted due to that particular load. The cutting strength value ranges between 50-60

From the above comparison, the cake prepared from whole egg replacing novel premix concentrate using Example 4 batch 4 and cake prepared from whole egg have their organoleptic, textural and colour properties comparable.

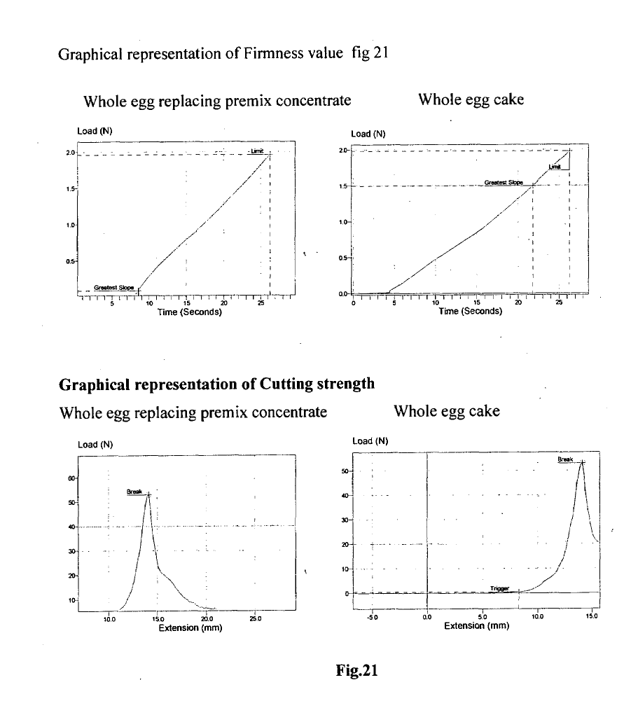

Graphical representation of Textural and colour properties of firmness values and cutting strength of the cake prepared from whole egg replacing premix concentrate from Example 4 batch 4 and cake from egg is presented in FIG. 21.

Nutritional profile studies of cake prepared from Egg and cake prepared from whole egg replacing novel premix concentrate using Example 4 Batch 4. The report summarized as follows:

| | | | Eggless cake | |
|---|---|---|---|---|
| | | | prepared from | |
| | | | whole egg | |
| | | | replacing novel | |
| | | | premix | |
| | | Cake prepared | concentrate from | Method of |
| | | from whole | Example 4 | analysis |
| S. No | Parameter | egg | Batch 4 | followed |
| 1. | Moisture (%) | 23.00 | 23.45 | Oven method at |
| | | | | 105 degrees |
| 2. | Protein (%) | 7.40 | 7.42 | Microkjeldahl |
| | | | | method |
| 3. | Fat (%) | 7.14 | 6.37 | Soxhlet |
| | | | | apparatus |
| 4. | Carbohydrate (%) | 61.13 | 61.23 | 100 − (Moisture |
| | | | | % + protein % + |
| | | | | fat % + ash %) |
| 5. | Ash (%) | 1.33 | 1.53 | Muffle furnace |
| | | | | method |
| 6. | Nutritional value | 338 | 332 | By calculation |
| | in kilo | | | |
| | calories/100 gm of cake | | | |

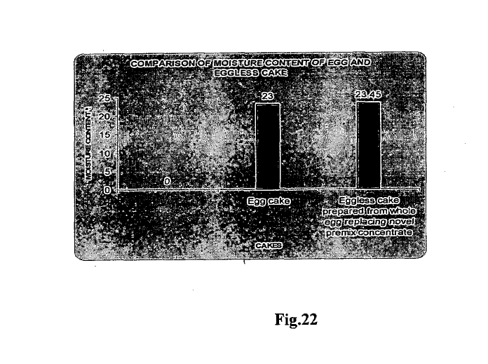

Moisture content: (oven method) Weigh the test specimen and dry it at 105 degrees for 2-3 hours. Remove it and cool the sample and weight it. Repeat the same until to get constant weight. Comparative study of moisture content of cake prepared from egg and cake from whole egg replacing novel premix concentrate from Example 4 Batch 4 is presented in FIG. 22.

### Protein (Micro Kieldahl Method)

Procedure: Distillation involves separation of ammonia—nitrogen from the digestate. This is accomplished by raising the pH with sodium hydroxide (NaOH). This changes the ammonium (NH₄+) ion to ammonia (NH₃). Now it is possible to separate the nitrogen by distilling the ammonia and collecting the distillate in a suitable trapping medium. Collection of ammonia is usually done by absorption into a solution of four percent boric acid. The ammonia is bound to the boric acid in the form of ammonium borate. Determination of the amount of nitrogen on the condensate flask can be accomplished by several methods. The most common is titration of the ammonia with a standard solution of one-tenth normal hydrochloric acid (0.1H HCl) in the presence of mixed indicator. The mixed indicators (bromocresol green and methyl red) are available in the four percent boric acid solution.

### Calculation

After all this chemistry it is now time to calculate the amount of nitrogen present in the sample. This calculation can either be performed as percent nitrogen or percent protein. For percent nitrogen: % N=14.01×(ml titrant−ml blank)−(N of titrant)×100 Sample Wt. (grams)×000(It has been shown that protein is 16% nitrogen. By dividing 100 by 16, we get the conversion factor for nitrogen to protein of 6.25. Hence, the percent protein is calculated as follows: % Protein=6.25×% N)

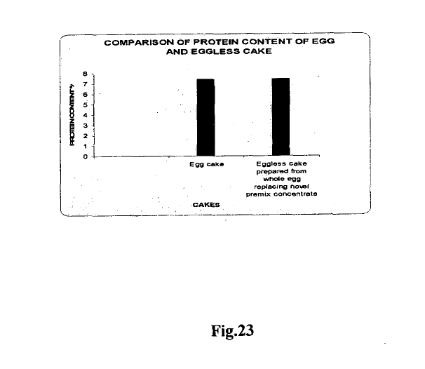

Graphical representation of the comparison of protein content of egg and egg less cake is presented in FIG. 23.

### Fat Content by Soxhlet Apparatus

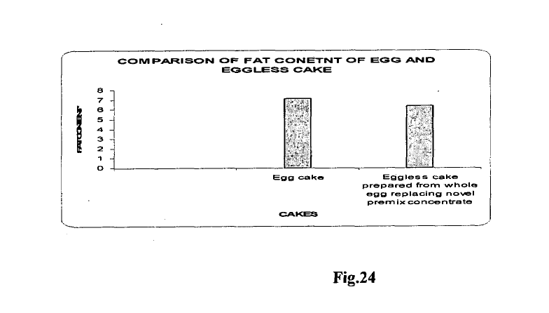

Fat is extracted, semicontinously, with an organic solvent. Solvent is heated and volatilized, then is condensed above the sample. Solvent drips onto the sample and soaks it to extract the fat. At 15-20 min intervals, the solvent us siphoned to the heating flask to start the process again. Fat content is measured by weight of sample or weight of fat removed. Graphical representation of comparison of Fat content of egg and eggless cake is depicted in FIG. 24.

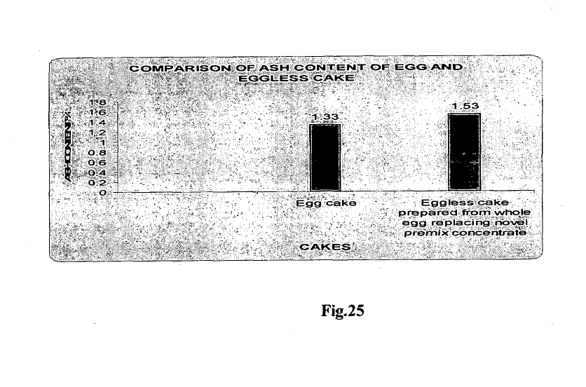

Ash by muffle furnace method: Weigh the test specimen and ash it in the crucible in muffle furnace at 550 degrees for 2-3 hours. Remove it from the furnace and cool and weight it. Repeat the same until to get constant weight. Graphical representation of comparison of ash content in egg and egg less cake is depicted in FIG. 25.

Carbohydrate: Carbohydrate is calculated by adding the % moisture, % fat, % protein and % ash and subtracting the same from 100%.

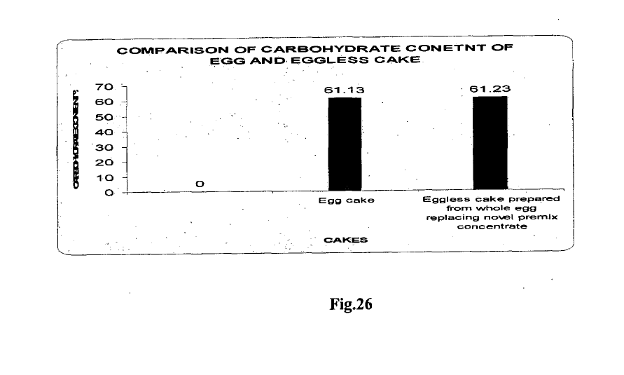

Graphical representation of comparison of content of carbohydrate in egg and egg less cake is shown in FIG. 26:

The energy (kilocalories) values comparison of cake prepared from whole egg and cake from whole egg replacing novel premix concentrate:

| Nutrient | Calories per gram |
|---|---|
| Carbohydrate | 4 k cal |
| Protein | 4 k cal |
| Fat | 9 k cal |

The comparison of caloric value of cake prepared from whole egg and cake prepared from whole egg replacing novel premix concentrate

| | | | | | Weight * factor = |
|---|---|---|---|---|---|
| | | Cake prepared | | Weight * | Kilo calories |
| | | from whole | | factor = | for cake from |
| | Cake | egg replacing | | Kilo | whole egg |
| | prepared | novel premix | | calories | replacing novel |
| | from egg | concentrate | | for whole | premix |
| Nutrient | Weight in % | Weight in % | Factor | egg cake | concentrate |
| Protein | 7.4 | 7.42 | 4k cal/gm | 29.6 | 29.68 |
| Carbohydrate | 61.13 | 61.23 | 4k cal/gm | 244.52 | 244.92 |
| Fat | 7.14 | 6.37 | 9k cal/gm | 64.26 | 57.33 |
| Total | | | | 338.38 | 331.93 |

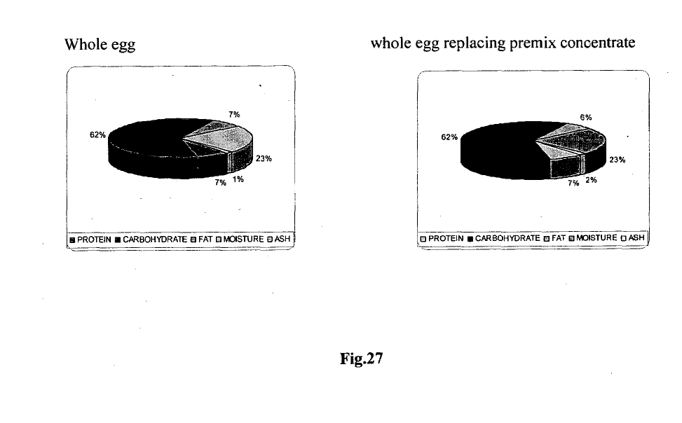

Graphical representation of nutritional profile of cake prepared from egg cake and cake prepared from whole egg replacing novel premix concentrate is depicted in FIG. 27.

### Comparison of Sensory Evaluation of Whole Egg and Eggless Cake:

The sensory Evaluation of cake prepared from egg and cake prepared from whole egg replacing novel premix concentrate was compared. The sensory evaluation study was conducted between different age group of people ranging from adults, children, middle aged people and old people. The results are summarized as follows

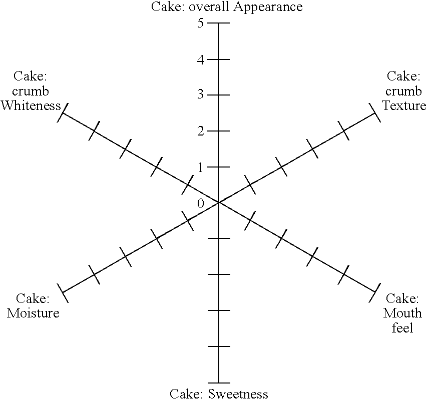

| | | Eggless cake | |
|---|---|---|---|
| | | prepared from | |
| | | whole egg | |
| | | replacing novel | |
| Characteristic | Whole Egg cake | premix concentrate | Remarks |
| Cake: overall | 4 | 4 | Both are |
| Appearance | | | same, no |
| | | | difference |
| Cake: crumb | 5 | 5 | Like |
| Texture | | | |
| Cake: Mouth feel | 5 | 5 | Like |
| Cake: Sweetness | 4 | 4 | Like |
| Cake: Moisture | 3 | 3 | Like |
| Cake: crumb | 5 | 5 | Like |
| Whiteness | | | |
| Cake: Overall score | 26 | 26 | Like |

Where 0-5 represents the hedonic scale,
0-represents the poor and
5-represents the excellent.

A Separate sensory evaluation test has been done for the cake prepared from whole egg and cake prepared from whole egg replacing novel premix concentrate.

To check the whole egg cake and cake prepared from whole egg replacing remix concentrate are identical or not:

The two cakes are marked as code A and Code B. Ask the people to taste and give their comments:

The results are summarized as follows

| Age group (volunteers) | Comments |
|---|---|
| Age group Below 16 | same |
| Adults | same |
| Middle aged people | same |
| Old people | same |

Thus from the above special sensory evaluation studies, the cake prepared from whole egg and cake prepared from whole egg replacing novel premix concentrate are identical.

The percentage of nutritional profile like protein, carbohydrate, and fat of the cake obtained from whole egg replacing novel premix concentrate of the present invention is comparable to the cake prepared from egg.

The energy values of the cake obtained from whole egg replacing novel premix concentrate of the present invention is comparable to the cake prepared from egg.

The sensory evaluation test proves that the cake prepared from whole egg and cake prepared from whole egg replacing novel premix concentrate is comparable.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

We claim:

1. A Whole egg replacing novel premix concentrate specially designed for cake and cake related products, wherein the said premix comprises of isolates of protein from gramineae family—10-30% with isolates of milk based protein ranging from 20-40% and in conjunction with the emulsifier ranging from 5-15%, leavening system ranging from 1-10%, stabilizers such as calcium, sodium potassium salts at about 7-10% with filler as starch and starch hydrolyzates.

2. The premix according to claim 1, wherein the protein from gramineae family comprises at least one cereal selected from the group consisting of barley, wheat, oats, rye or maize which delivers extensibility, film forming properties and moisture management in cakes.

3. The premix according to claim 1, wherein the isolates of milk based protein comprises at least one selected from the group of casein, whey protein isolates and concentrates, milk condensates.

4. The premix according to claim 1, wherein the said emulsifiers are selected from the group such as sodium and calcium stearoyl lactylate, ethoxylated mono and di glycerides, polysorbates, succinylated mono glycerides, diacetyl tartaric acid esters of mono glycerides, acetic acid ester of mono glycerides, lactic acid ester of mono glycerides, or propylene glycerol esters of fatty acids.

5. The premix according to claim 1 wherein the said leavening systems are selected from sodium bi carbonate, sodium acid pyro phosphate; sodium aluminum sulphate or potassium tartrate.

6. The premix according to claim 1 wherein the said stabilizers are selected from chloride salts of sodium, calcium and potassium.

7. The premix according to claim 1 wherein the said fillers are selected from starch and starch hyrolysates such as corn starch, maize starch or in combination with starch-maltodextrin or potato starch.

8. A method for preparing cake and cake related products from Whole egg replacing novel premix concentrate is as follows
a) whisking the sugar and water until the sugar dissolves;
b) adding cake gel, flour mixed with the eggless concentrate with 60 revolutions speed followed by a high speed of 180 revolutions until the uniform mixture obtained;
c) adding oil by mixing it in slow speed of 60 revolutions for 30 seconds; and
d) baking the mixture in cake pan of smaller size (6″-2″) and larger pan size of (6½-2½ inch) of batter weight 250 gms and 600 gms respectively.

9. A method as claimed in claim 8 wherein the said premix is added in the range of 30 to 40% on flour weight basis to prepare cake and cake related products.
